(19) United States
(12) Patent Application Publication
(10) Pub. No.: US 2026/0244058 A1
(43) Pub. Date: Aug. 20, 2026

(54) DISPLAY PANEL AND DISPLAY APPARATUS

(71) Applicants: Beijing BOE Display Technology Co., Ltd., Beijing (CN); BOE Technology Group Co., Ltd., Beijing (CN)

(72) Inventors: Qiujie SU, Beijing (CN); Lingdan BO, Beijing (CN); Yingying QU, Beijing (CN); Yingmeng MIAO, Beijing (CN)

(21) Appl. No.: 18/992,985

(22) PCT Filed: May 24, 2024
(86) PCT No.: PCT/CN2024/095186

§ 371 Date: Jan. 10, 2025

(30) Foreign Application Priority Data
May 29, 2023 (CN) 202310621238.5

(51) Int. Cl. G02F 1/1362; G02F 1/1368

(52) U.S. Cl. CPC G02F 1/136286; G02F 1/136209; G02F 1/136218; G02F 1/136227; G02F 1/1368

(57) ABSTRACT

A display panel and a display apparatus. The display panel comprises: a base substrate (1), wherein the base substrate (1) is provided with at least two gate lines (2) and at least two data lines (3), and the gate lines (2) and the data lines (3) overlap one another on the base substrate (1) in an insulated manner to form pixel regions; a pixel electrode (4), provided on the side of the base substrate (1) close to the pixel regions, wherein the pixel electrode (4) is connected to the data lines (3); and a common electrode (5), provided on the side of the gate lines (2) and the data lines (3) away from the base substrate (1), wherein the orthographic projection of the common electrode (5) on the base substrate (1) covers the orthographic projections of the gate lines (2) and/or the data lines (3) on the base substrate (1).

### CROSS-REFERENCE TO RELATED APPLICATIONS

The present application is a U.S. National Phase Entry of International Application No. PCT/CN2024/095186 having an international filing date of May 24, 2024, which claims priority to the Chinese Patent Application No. 202310621238.5 filed to the CNIPA on May 29, 2023, the above-identified applications are incorporated herein by reference in their entireties.

### TECHNICAL FIELD

Embodiments of the present disclosure relate to, but are not limited to, the field of display technologies, and particularly to a display panel and a display apparatus.

### BACKGROUND

Liquid Crystal Display panel (LCD) has the advantages such as low power consumption, thin appearance, light weight and low drive voltage. It is widely used in modern information equipment such as TVs, computers, cell phones and other digital products. The LCD contains a plurality of gate lines and a plurality of data lines, which are used as drive circuits of the display panel. Often times, the gate lines and data lines are made of metal materials, and when the display panel is used, a relatively disorderly electric field will be generated around the gate lines or data lines, and the disorderly electric field will interfere with the liquid crystal molecules arranged around them, thus causing light leakage on two sides of the gate lines and data lines. Therefore, the gate lines and data lines are often covered with a wider Black Matrix (BM) layer. However, a wider Black Matrix layer will reduce the aperture ratio of the pixel region, reduce the light effect of the pixel region, and then affect the display effect of the display panel.

### SUMMARY

The following is a summary of a subject matter described in the present disclosure in detail. This summary is not intended to limit the protection scope of claims.

An embodiment of the present disclosure provides a display panel, including:
a base substrate on which at least two gate lines and at least two data lines are disposed, wherein the gate lines and the data lines are insulated and crossed on the base substrate to form pixel regions;
a pixel electrode disposed at a side of the base substrate close to the pixel regions, wherein the pixel electrode is connected to a data line; and
a common electrode disposed at a side of the gate line and the data line away from the base substrate, wherein an orthographic projection of the common electrode on the base substrate covers an orthographic projection of the gate line and/or an orthographic projection of the data line on the base substrate.

In some embodiments, when the display panel adopts positive liquid crystal, the orthographic projection of the common electrode on the base substrate covers the orthographic projection of the gate line on the base substrate; and when the display panel adopts negative liquid crystal, the orthographic projection of the common electrode on the base substrate covers the orthographic projection of the data line on the base substrate.

In some embodiments, the common electrode includes:
a first electrode layer disposed at the side of the gate line and the data line away from the base substrate, and disposed at a side of the pixel electrode away from the base substrate; and
a domain display region including a plurality of parallel slits provided on the first electrode layer, wherein a first shield electrode is formed at a slit of adjacent pixel regions, and an orthographic projection of the first shield electrode on the base substrate covers the orthographic projection of the gate line on the base substrate.

In some embodiments, the common electrode further includes: a second shield electrode disposed between adjacent pixel regions, an orthographic projection of the second shield electrode on the base substrate covers the orthographic projection of the data line on the base substrate.

In some embodiments, when the display panel adopts negative liquid crystal, the second shield electrode is disposed at the side of the data line away from the base substrate.

In some embodiments, the common electrode includes:
a second electrode layer disposed at the side of the gate line and the data line away from the base substrate and at a side of the pixel electrode close to the base substrate, and an orthographic projection of the second electrode layer on the base substrate covers the orthographic projection of the gate line and/or the orthographic projection of the data line on the base substrate.

In some embodiments, when the display panel adopts negative liquid crystal, the second electrode layer is disposed at the side of the data line away from the base substrate; and when the display panel adopts positive liquid crystal, the second electrode layer is disposed at the side of the gate line away from the base substrate.

In some embodiments, an end surface of the slit close to the data line is configured as a planer surface or an arc surface.

In some embodiments, at least two of the domain display regions are provided in a pixel region, and directions of slits in adjacent domain display regions are different so that a cross-domain region is formed between adjacent two domain display regions.

In some embodiments, the display panel further includes:
a common line disposed at the side of the base substrate close to the pixel regions and connected to the common electrode, wherein an orthographic projection of the common line on the base substrate is overlapped with an orthographic projection of the cross-domain region on the base substrate; or disposed at the side of the base substrate close to the pixel region, wherein an extension direction of the common line is the same as an extension direction of the data line, and a distance between the common line and the data line is set to be 4 μm to 10 μm.

In some embodiments, a black matrix layer is disposed in the cross-domain region and shields the common line.

In some embodiments, the common line is disposed at a side of the data line, and an extension direction of the common line is the same as an extension direction of the data line.

In some embodiments, the display panel further includes: an organic film layer disposed at the side of the gate line and the data line away from the base substrate, and the organic film layer is disposed at a side of the common electrode close to the base substrate.

In some embodiments, the data line is provided with a bearing portion having a width larger than a width of the data line, a spacer is disposed at a side of the bearing portion away from the base substrate, and an orthographic projection of the spacer on the base substrate is located within an orthographic projection of the bearing portion on the base substrate.

Based on the same inventive concept, the present application further provides a display apparatus including the display panel according to any one of the above embodiments.

Other aspects of the present disclosure may be comprehended after the drawings and the detailed descriptions are read and understood.

### BRIEF DESCRIPTION OF DRAWINGS

In order to describe technical solutions in the present application or related technologies more clearly, the drawings to be used in describing the embodiments or related technologies will be introduced below in brief. Apparently, the drawings described below are only embodiments of the present application and those of ordinary skills in the art may also obtain other drawings according to these drawings without paying any inventive effort.

FIG. 1a is a schematic diagram of a structure of an existing display panel.

FIG. 1b is a schematic diagram of a structure of an existing pixel region.

FIG. 2 is a schematic diagram of a planar structure of a display panel according to an embodiment of the present disclosure.

FIG. 3a is a schematic diagram of a structure of a region A-A′ in a first state in FIG. 2.

FIG. 3b is a schematic diagram of a structure of a region B-B′ in the first state in FIG. 2.

FIG. 3c is a schematic diagram of a structure of a region C-C′ in the first state in FIG. 2.

FIG. 4a is a schematic diagram of a structure of the region A-A′ in a second state in FIG. 2. FIG. 4b is a schematic diagram of a structure of the region B-B′ in the second state in FIG. 2.

FIG. 4c is a schematic diagram of a structure of the region C-C′ in the second state in FIG. 2.

FIG. 5a is a schematic diagram of a structure of the region A-A′ in a third state in FIG. 2.

FIG. 5b is a schematic diagram of a structure of the region B-B′ in the third state in FIG. 2. FIG. 5c is a schematic diagram of a structure of the region C-C′ in the third state of FIG. 2 FIG. 6a is a schematic diagram of a structure of the region A-A′ in a fourth state in FIG. 2. FIG. 6b is a schematic diagram of a structure of the region B-B′ in the fourth state in FIG. 2.

FIG. 6c is a schematic diagram of a structure of the region C-C′ in the fourth state in FIG. 2.

FIG. 7a is a schematic diagram of a structure of the region A-A′ in a fifth state in FIG. 2.

FIG. 7b is a schematic diagram of a structure of the region B-B′ in the fifth state in FIG. 2. FIG. 7c is a schematic diagram of a structure of the region C-C′ in the fifth state in FIG. 2. FIG. 8a is a schematic diagram of a structure of the region A-A′ in a sixth state in FIG. 2. FIG. 8b is a schematic diagram of a structure of the region B-B′ in the sixth state in FIG. 2. FIG. 8c is a schematic diagram of a structure of the region C-C′ in the sixth state in FIG. 2. FIG. 9 is a schematic diagram of a structure of a cross-domain region according to an embodiment of the present disclosure.

FIG. 10a is a schematic diagram of a structure of a slit in a first form according to an embodiment of the present disclosure.

FIG. 10b is a schematic diagram of a structure of a slit in a second form according to an embodiment of the present disclosure.

FIG. 11a is a schematic diagram of a structure of a common line in a cross-domain region according to an embodiment of the present disclosure.

FIG. 11b is a schematic diagram of a common line in a cross-domain region according to an embodiment of the present disclosure.

FIG. 11c is a schematic diagram of a structure of a common line according to an embodiment of the present disclosure.

### DETAILED DESCRIPTION

In order to make the objects, technical solutions, and advantages of the present application more clearly understood, the present application will be described in further detail with reference to the following embodiments and the accompanying drawings.

It should be noted that, unless otherwise defined, technical terms or scientific terms used in the embodiments of the present application shall have general meanings understood by those skilled in the art to which the embodiments of the present application pertains. “First”, “second”, and similar terms used in the embodiments of the present application do not represent any sequence, number, or significance, but are only adopted to distinguish different components. “Include”, “contain”, or similar words mean that elements or objects appearing before the words cover elements or objects listed after the words and their equivalents, but do not exclude other elements or objects. “Connect”, “couple”, or similar words are not limited to a physical or mechanical connection, but may include an electrical connection, whether direct or indirect. “Upper”, “lower”, “left”, and “right”, etc., are used for representing a relative positional relationship, and when an absolute position of a described object is changed, the relative positional relationship may also be correspondingly changed.

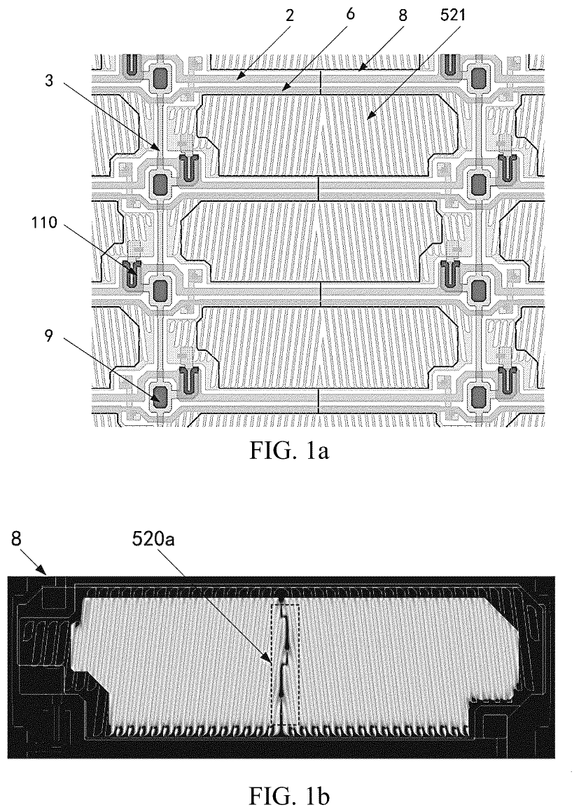

In related technologies, LCD has the advantages such as low power consumption, thin appearance, light weight and low drive voltage. It is widely used in modern information equipment such as TVs, computers, cell phones and other digital products. As shown in FIGS. 1a and 1b, the LCD includes a plurality of gate lines, a plurality of data lines, and a common line, which serve as a drive circuit of the display panel, and correspondingly, the display panel is further provided with a common line, and the common line and the gate lines are arranged in parallel. Often times, the gate lines and data lines are made of metal materials, and when the display panel is used, a relatively disorderly electric field will be generated around the gate lines or data lines, and the disorderly electric field will interfere with the liquid crystal molecules arranged around them, thus causing light leakage on two sides of the gate lines and data lines. Therefore, the gate lines and data lines are often covered with a wider Black Matrix (BM) layer. However, a wider Black Matrix layer will reduce the aperture ratio of the pixel region, reduce the light effect of the pixel region, and then affect the display effect of the display panel.

An embodiment of the present disclosure provides a display panel, including: a base substrate 1, on which at least two gate lines 2 and at least two data lines 3 are provided, herein the gate lines 2 and the data lines 3 are insulated and crossed on the base substrate 1 to form pixel regions; a pixel electrode 4 disposed at a side of the base substrate 1 close to a pixel region, herein the pixel electrode 4 is connected to a data line 3; a common electrode 5 disposed at a side of a gate line 2 and a data line 3 away from the base substrate 1, herein an orthographic projection of the common electrode 5 on the base substrate 1 covers an orthographic projection of the gate line 2 and/or an orthographic projection of the data line 3 on the base substrate 1.

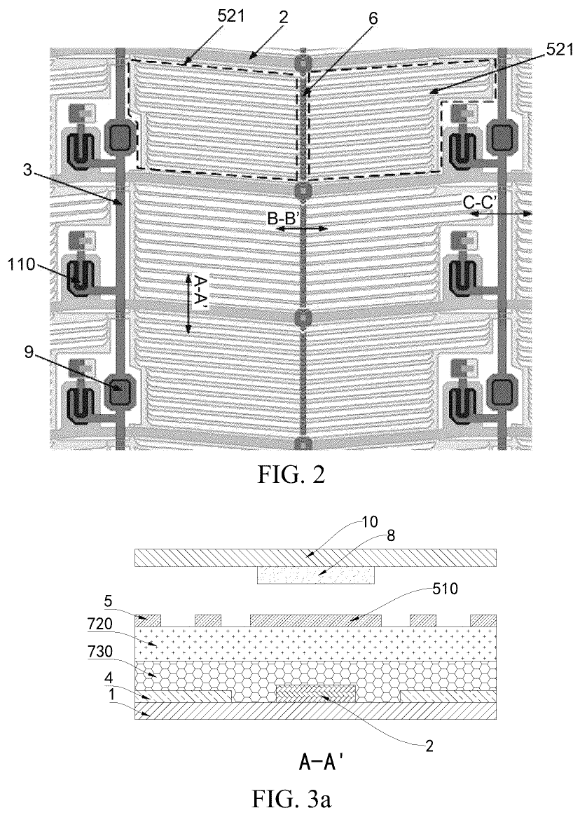

In some embodiments, with reference to FIGS. 2 to 11c, the display panel includes a base substrate 1, and the base substrate 1 supports and protects components and film layers disposed on the surface thereof. At least two gate lines 2 and at least two data lines 3 are insulated and alternately disposed on the base substrate 1, and at least two gate lines 2 and at least two data lines 3 form a plurality of pixel regions on the base substrate 1. The display panel further includes a pixel electrode 4 and a common electrode 5. When the display panel operates, a voltage is generated between the pixel electrode 4 and the common electrode 5, which can drive the liquid crystal molecules to deflect so that light can pass through the pixel region, so that the display panel can achieve the display function. Herein, the pixel electrode 4 may be a red pixel electrode 4, a green pixel electrode 4 or a blue pixel electrode 4, so as to be suitable for different types of pixel regions. When the display panel operates, a disorderly electric field will be generated around the gate line 2 and the data line 3, causing interference to the surrounding liquid crystal molecules, and light leakage phenomenon will occur around the gate line 2 and the data line 3. By arranging the common electrode 5 at a side of the gate line 2 and the data line 3 away from the base substrate 1, and making the orthographic projection of the common electrode 5 on the base substrate 1 cover the orthographic projection of the gate line 2 and/or the orthographic projection of the data line 3 on the base substrate 1, the common electrode 5 can form a shield layer for shielding the disorderly electric field generated by the data line 3 and/or the gate line 2, avoiding light leakage phenomenon on two sides of the gate line 2 and/or the data line 3, reducing the area required by the gate line 2 and the data line 3 on the black matrix layer 8, thereby improving the aperture ratio of the pixel region.

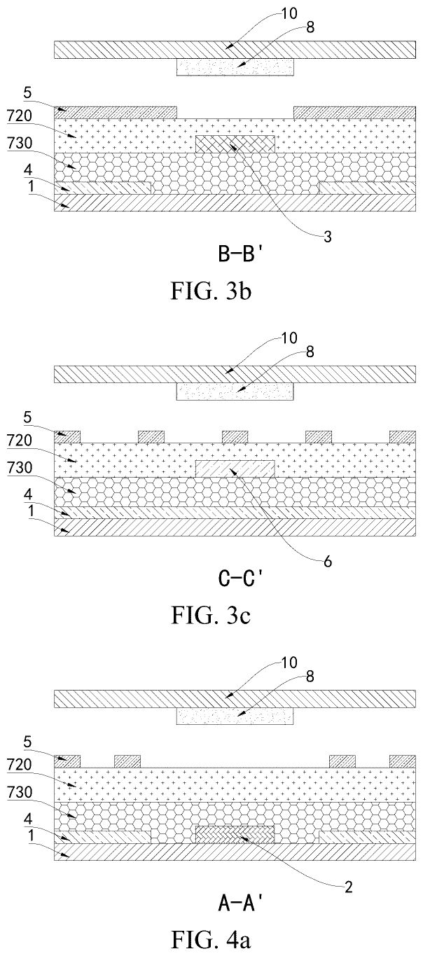

For example, with reference to FIGS. 3a-3c, when the display panel adopts positive liquid crystal, the common electrode 5 may be provided at a side of the gate line 2 away from the base substrate 1 so that an orthographic projection of the common electrode 5 on the base substrate 1 covers an orthographic projection of the gate line 2 on the base substrate 1. At this time, the common electrode 5 can shield the disorderly electric field generated by the gate line 2, avoiding light leakage on two sides of the gate line 2, reducing the area of the black matrix layer 8 for covering the gate line 2, and improving the aperture ratio of the pixel region. In addition, it should be noted that, since the electric field generated by the common electrode 5 and the data line 3 may not make the positive liquid crystal deflect, the common electrode 5 does not need to shield the data line 3 at this time.

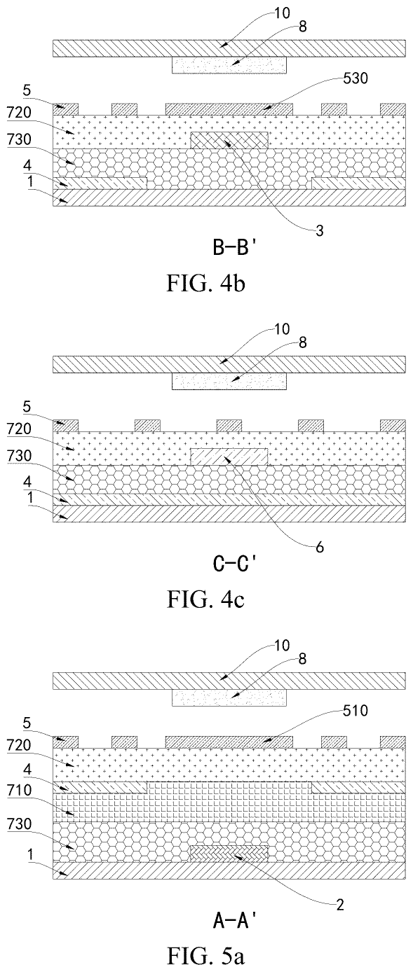

For another example, with reference to FIGS. 4a-4c, when the display panel adopts negative liquid crystal, the common electrode 5 may be disposed at a side of the gate line 2 away from the base substrate 1, so that an orthographic projection of the common electrode 5 on the base substrate 1 covers an orthographic projection of the data line 3 on the base substrate 1. At this time, the common electrode 5 can shield the disorderly electric field generated by the data line 3, avoiding light leakage on two sides of the data line 3, reducing the area of the black matrix layer 8 for covering the data line 3, thus improving the aperture ratio of the pixel region. Similarly, since the electric field generated by the common electrode 5 and the gate line 2 may not make the negative liquid crystal deflect, the common electrode 5 does not need to shield the gate line 2 at this time.

It should be noted that, with reference to FIGS. 3a to 8c, in the display panel, the base substrate 1 is used for supporting and protecting components and related film layers provided on the surface thereof. The base substrate 1 may include a base layer, a Thin Film Transistor 110 (TFT), and a Gate Insulator layer 730 (GI). The base layer may be made of one or more materials such as glass, polyimide, and polycarbonate, so that the base layer has better impact resistance and water-oxygen barrier ability, and effectively prolongs the life of the display panel.

The thin film transistor 110 may be provided on the base layer, and the thin film transistor 110 may be respectively connected to the corresponding data line 3 and the gate line 2 to serve as a drive circuit of the display panel. The thin film transistor 110 includes an active layer, a gate electrode, a source electrode, and a drain electrode. The active layer may be provided on the base layer and may be made of an oxide semiconductor material or an organic semiconductor material. The gate insulator layer 730 may be disposed on the base layer, the active layer is disposed in the gate insulator layer 730, the active layer and the source electrode are insulated by using the gate insulator layer 730, or the active layer and the drain electrode are insulated by using the gate insulator layer 730, so the gate insulator layer 730 needs to be made of an insulating material, such as silicon nitride or silicon oxide of an inorganic material, and the insulation effect of the gate insulator layer 730 is ensured. The gate insulator layer 730 may be of one layer or multiple layers. Both the source electrode and the drain electrode may be disposed at a side of the gate insulator layer 730 away from the active layer, and may be spaced apart from each other. The source electrode and the drain electrode may be made of one material of molybdenum, aluminum, chromium, gold, titanium, nickel, neodymium, and copper, or made of an alloy of a plurality of compositions thereof, and will not be described herein.

In addition, the base substrate 1 further includes a Passivation Layer 720 (PVX), and the passivation layer 720 may be disposed at a side of the gate insulator layer 730 away from the base layer, and may be used for planarizing the thin film transistor 110 and the gate insulator layer 730, and may be used for protecting components provided on the base layer. The passivation layer 720 may be made of one or more of a polyacrylate resin, an epoxy resin, a phenolic resin, a polyamide resin, a polyimide resin, and a polyphenylene resin, and will not be described herein.

It should be noted that the common electrode 5 and the pixel electrode 4 may be made of transparent metal electrodes so that light may pass through the pixel electrode 4 and the common electrode 5 to be projected to the outside of the pixel unit, for example, transparent electrodes made of materials such as indium tin oxide, indium zinc oxide, zinc oxide, and indium oxide, and this will not be described herein.

In some embodiments, the common electrode 5 includes a first electrode layer 510 disposed at a side of the gate line 2 and the data line 3 away from the base substrate 1, and disposed at a side of the pixel electrode 4 away from the base substrate 1; a domain display region 520, which includes a plurality of parallel slits 521 opened on the first electrode layer 510, herein a first shield electrode 522 is formed at the slit 521 of adjacent pixel regions, and an orthographic projection of the first shield electrode 522 on the base substrate 1 covers an orthographic projection of the gate line 2 on the base substrate 1.

In some embodiments, with reference to FIGS. 3a-6c and 9, a voltage is generated between the pixel electrode 4 and the common electrode 5 provided on the base substrate 1 to drive the liquid crystal molecules to deflect, so that the display panel achieves the display function. The common electrode 5 may include a first electrode layer 510 and a domain display region 520, and a corresponding voltage may be generated between the pixel electrode 4 and the first electrode layer 510 to drive the liquid crystal molecules to deflect. The domain display region 520 is provided with a plurality of parallel slits 521, and the plurality of slits 521 are arranged in the first electrode layer 510 so that a corresponding electric field is generated in the edge regions of the slits 521, and a multi-dimensional electric field is formed in combination with the electric field generated between the first electrode layer 510 and the pixel electrode 4, which may better control the arrangement direction and deflection form of liquid crystal molecules, thereby improving the display effect of the display panel.

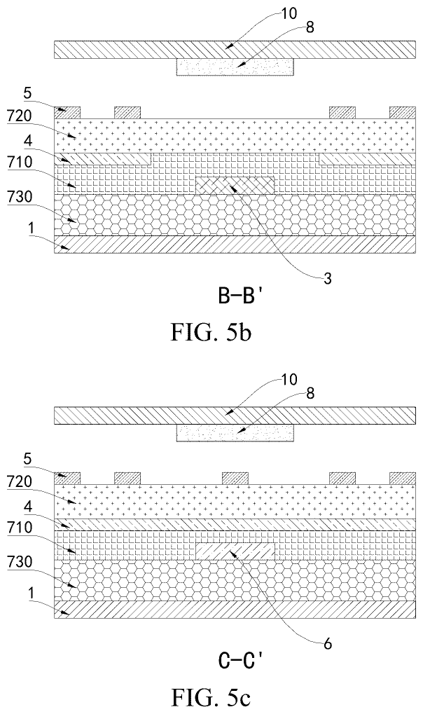

In addition, a first shield electrode 522 is formed at the slit 521 between adjacent pixel regions, that is, the first shield electrode 522 is located between two adjacent pixel regions, and the first shield electrode 522 may be disposed parallel to the gate line 2, so that an orthographic projection of the first shield electrode 522 on the base substrate 1 covers an orthographic projection of the gate line 2 on the base substrate 1. At this time, as shown in FIGS. 5a to 5c, when the display panel adopts positive liquid crystal, an orthographic projection of the first shield electrode 522 on the base substrate 1 covers an orthographic projection of the gate line 2 on the base substrate 1, and at this time, the first shield electrode 522 can shield the disorderly electric field generated by the gate line 2, avoiding light leakage phenomenon on two sides of the gate line 2, reducing the coverage area of the black matrix layer 8 on the gate line 2, thus improving the aperture ratio of the pixel region.

In some embodiments, the common electrode 5 further includes a second shield electrode 530 disposed between adjacent pixel regions, and an orthographic projection of the second shield electrode 530 on the base substrate 1 covers an orthographic projection of the data line 3 on the base substrate 1.

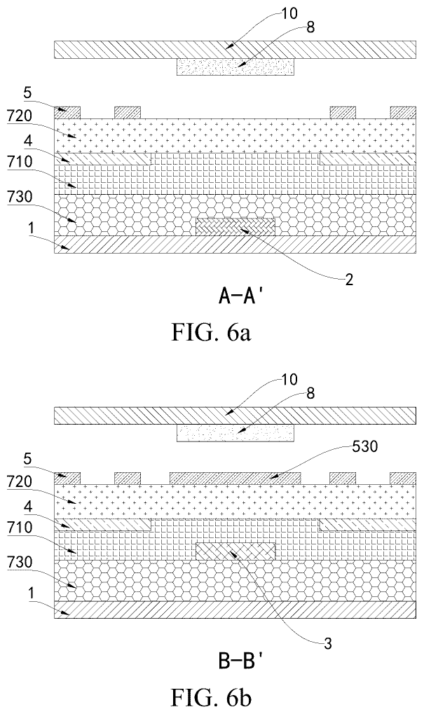

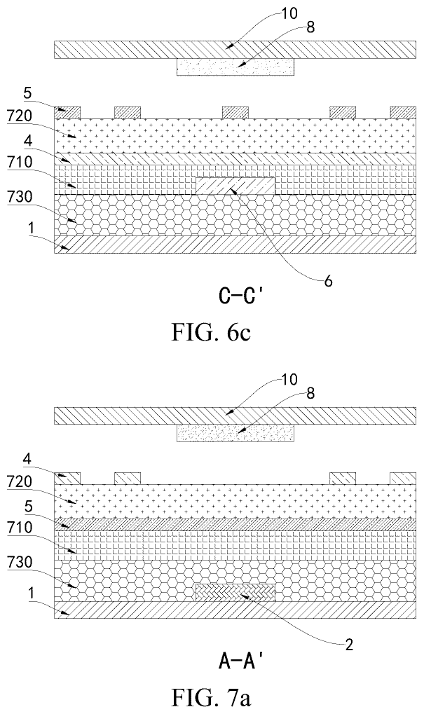

In some embodiments, with reference to FIGS. 6a-6c, since the common electrode 5 is disposed at a side of the gate line 2 and the data line 3 away from the base substrate 1, the common electrode 5 can shield the disorderly electric field generated by the gate line 2 and/or the data line 3 to avoid light leakage on two sides of the gate line 2 and/or the data line 3. The common electrode 5 includes a second shield electrode 530 for shielding the data line 3, an orthographic projection of the second shield electrode 530 on the base substrate 1 covers an orthographic projection of the data line 3 on the base substrate 1, and when the display panel adopts negative liquid crystal, the second shield electrode 530 is arranged at a side of the data line 3 away from the base substrate 1, causing an orthographic projection of the second shield electrode 530 on the base substrate 1 to cover an orthographic projection of the data line 3 on the base substrate 1. At this time, the second shield electrode 530 can shield the disorderly electric field generated by the data line 3, avoiding light leakage phenomenon on two sides of the data line 3, reducing the coverage area of the black matrix layer 8 on the data line 3, and thus improving the aperture ratio of the pixel region.

In some embodiments, the common electrode 5 includes a second electrode layer disposed at a side of the gate line 2 and the data line 3 away from the base substrate 1 and disposed at a side of the pixel electrode 4 close to the base substrate 1, and an orthographic projection of the second electrode layer of the common electrode 5 on the base substrate 1 covers an orthographic projection of the gate line 2 and/or an orthographic projection of the data line 3 on the base substrate 1.

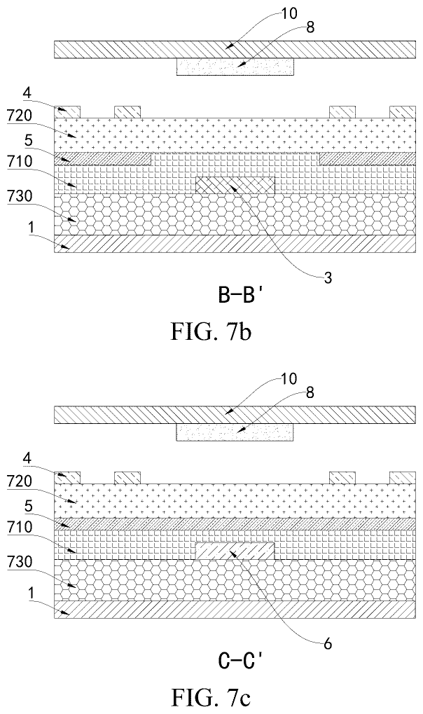

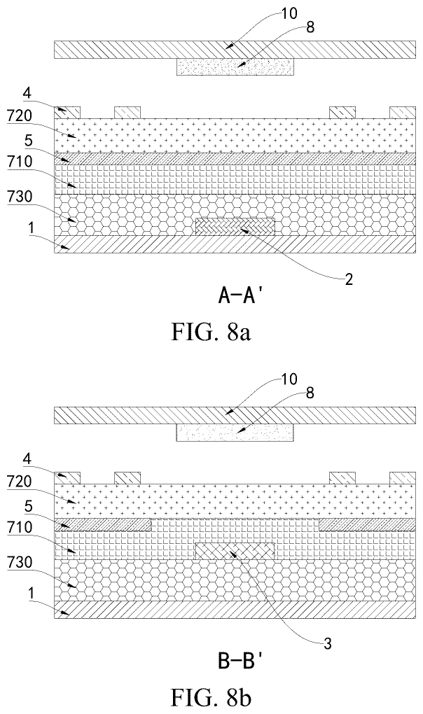

In some embodiments, a second electrode layer of the common electrode 5 is disposed at a side of the pixel electrode 4 close to the base substrate 1, and an orthographic projection of the second electrode layer on the base substrate 1 covers an orthographic projection of the gate line 2 and/or an orthographic projection of the data line 3 on the base substrate 1. For example, with reference to FIGS. 7a-7c, when the display panel adopts negative liquid crystal, the second electrode layer is disposed at a side of the data line 3 away from the base substrate 1, and an orthographic projection of the base substrate 1 covers an orthographic projection of the data line 3 on the base substrate 1. At this time, the second electrode layer can shield the disorderly electric field generated by the data line 3, thus avoiding light leakage on two sides of the data line 3, reducing the coverage area of the black matrix layer 8 on the data line 3, increasing the aperture ratio of the pixel region, and improving the display effect of the display panel. Since the electric field generated between the second electrode layer and the gate line 2 may not deflect the negative liquid crystal, the second electrode layer does not need to shield the gate line 2.

For another example, when the display panel adopts positive liquid crystal, with reference to FIGS. 8a to 8c, the second electrode layer of the common electrode 5 is provided at a side of the gate line 2 away from the base substrate 1, and its orthographic projection on the base substrate 1 covers an orthographic projection of the gate line 2 on the base substrate 1. At this time, the second electrode layer can shield the disorderly electric field generated by the gate line 2, avoid light leakage on two sides of the gate line 2, reduce the coverage area of the black matrix layer 8 on the gate line 2, and increase the aperture ratio of the pixel region. At the same time, since the electric field generated between the second electrode layer and the data line 3 may not deflect the positive liquid crystal, the second electrode layer does not need to shield the data line 3.

In some embodiments, the end surface of the slit 521 close to the data line 3 is configured as a planar surface or an arc surface.

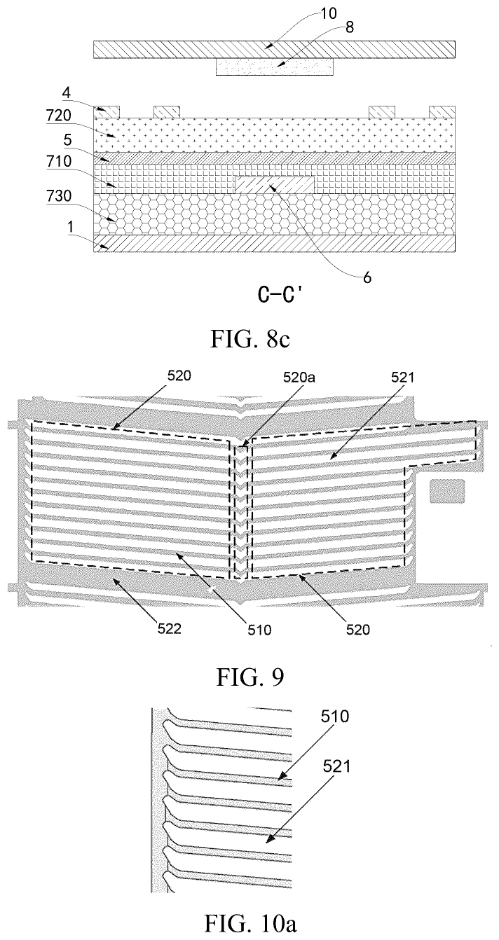

In some embodiments, when the display panel is subjected to external pressure, the liquid crystal molecules with a large inclination angle are squeezed and rearranged, causing a change in the light transmittance in the pixel region. After the external pressure is withdrawn, the rearranged liquid crystal molecules cannot return to the original position in a short time under the force of the electric field, and the display effect of the display panel is thereby reduced. Referring to FIGS. 10a and 10b, by configuring the end portion of the slit 521 as a planer surface or an arc surface, it is possible to reduce the influence of external pressure on the electric field in the edge region of the slit 521, thereby reducing the interference on the arrangement of liquid crystal molecules, and ensuring the light transmittance effect of the pixel region.

In some embodiments, at least two domain display regions 520 are provided in the pixel region, and the directions of the slits 521 in the adjacent domain display regions 520 are different, so that a cross-domain region 520a is formed between the two adjacent domain display regions 520.

In some embodiments, with reference to FIG. 9, at least two domain display regions 520 are provided in any pixel region, and in the two adjacent domain display regions 520, the corresponding slits 521 in each domain display region 520 have different extension directions, so the deflection directions of liquid crystal molecules in different domain display regions 520 are also different, so that the light effects of viewing the display panel at different angles tend to be consistent, and the brightness and color shift degree of the display panel are improved. Since the deflection directions of the liquid crystals in the two domain display regions 520 are different, a cross-domain region 520a with poor light transmittance is formed between the adjacent domain display regions 520. In any pixel region, the number of domain display regions 520 may be two, three, or even more according to the area of the pixel region and the light transmittance effect, and this will not be described herein.

In some embodiments, the display panel further includes a common line 6 disposed at a side of the base substrate 1 close to the pixel region, the common line 6 is connected to the common electrode 5, and an orthographic projection of the common line 6 on the base substrate 1 is overlapped with an orthographic projection of the cross-domain region 520a on the base substrate 1.

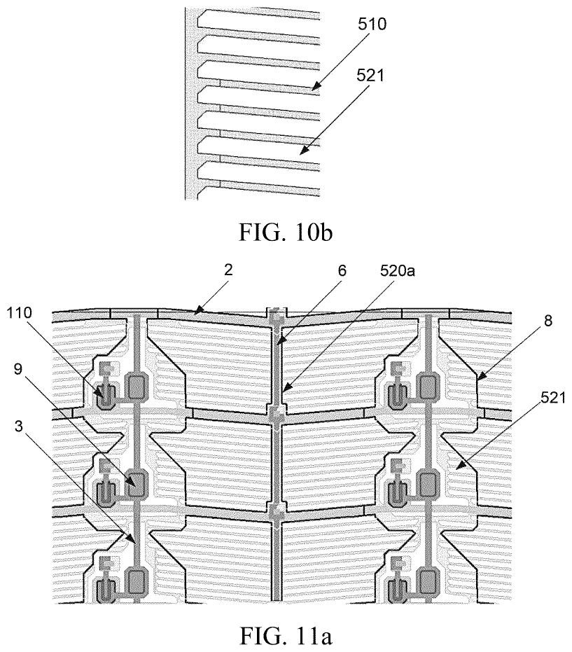

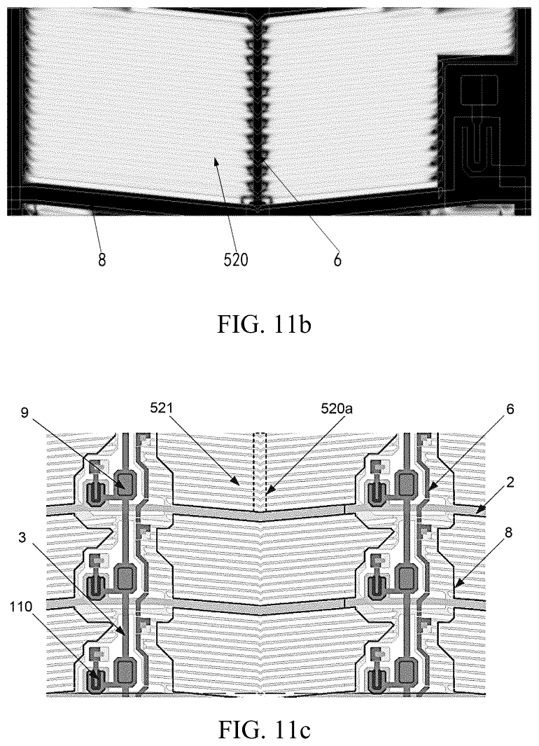

In some embodiments, with reference to FIG. 11a, the base substrate 1 includes a common line 6 connected to a common electrode 5 besides a common line 6 forming a pixel region. Since the common line 6 is a metal trace, in order to reduce the impact of the common line 6 on the light effect of the pixel region, it is necessary to cover the common line 6 with the black matrix layer 8. For any pixel region, two domain display regions 520 are provided inside any pixel region, and a cross-domain region 520a is formed between adjacent domain display regions 520. As shown in FIGS. 1b and 11b, since the light transmittance between the adjacent domain display regions 520 is poor, by arranging the common line 6 in the cross-domain region 520a, an orthographic projection of the common line 6 on the base substrate 1 is caused to be overlapped with an orthographic projection of the cross-domain region 520a on the base substrate 1, that is, the common line 6 is arranged in the region with poor light transmittance in the pixel region. Therefore, a black matrix layer 8 for shielding the common line 6 may be provided in the cross-domain region 520a. On the one hand, the influence of the black matrix layer 8 arranged in this region on the aperture ratio of the pixel region can be reduced; on the other hand, the cross-domain region 520a shields at least a part of the common line 6, thus improving the shielding effect for the common line 6, thereby improving the light effect and the aperture ratio of the pixel region.

As an alternative embodiment, the display panel further includes a common line 6 disposed at a side of the base substrate 1 close to the pixel region, the common line 6 is connected to the common electrode 5, the extension direction of the common line 6 is the same as the extension direction of the data line 3, and a distance between the common line 6 and the data line 3 is set to be 4 μm-10 μm.

In some embodiments, with reference to FIG. 11c, the gate line 2 and the data line 3 are provided on the base substrate 1, and the gate line 2 and the data line 3 are metal traces, so it is necessary to cover the gate line 2 and the data line 3 with the black matrix layer 8 to avoid light leakage phenomenon in pixel regions and to prevent color mixing phenomenon between adjacent pixel regions. Since a spacer is provided on the light shield layer covering the data line 3, in the display panel, in order to prevent the spacer from sliding out of the light shield layer arranged on the data line 3 and scratching the film layer, a width of the black matrix layer 8 covering the data line 3 is usually large, thus affecting the aperture ratio of the pixel region. By arranging the common line 6 to be beside the data line 3 and making its extension direction the same as that of the data line 3, the black matrix layer 8 covering the data line 3 may be used to shield the common line 6 at the same time, so that the common line 6 may be covered by using the black matrix layer 8 of the data line 3, thus omitting the original black matrix layer 8 covering the common line 6, thereby improving the aperture ratio of the pixel region.

Further, in order to avoid the formation of electric fields that mutually interfere with each other between the common line 6 and the data line 3, a distance between the data line 3 and the common line 6 should be greater than 4um, and in order to make the black matrix layer 8 covering the data line 3 completely cover the common line 6 and ensure the aperture ratio of the pixel region, a distance between the data line 3 and the common line 6 should be set to be less than 10 μm.

In some embodiments, the display panel further includes an organic film layer 710 disposed at a side of the gate line 2 and the data line 3 away from the base substrate 1, and the organic film layer 710 is disposed at a side of the common electrode 5 close to the base substrate 1.

In some embodiments, with reference to FIGS. 5a-8c, the organic film layer 710 is disposed at a side of the gate line 2 and the data line 3 away from the base substrate 1, and the organic film layer 710 is disposed at a side of the common electrode 5 close to the base substrate 1, so that there is at least one insulator layer between the common electrode 5 and the gate line 2 to provide insulation and rejection between the common electrode 5 and the data line 3; and/or to provide insulation and rejection between the common electrode 5 and the gate line 2, to avoid parasitic capacitor being formed between the common electrode 5 and the data line 3 and/or between the common electrode 5 and the gate line 2, thereby ensuring the display effect of the display panel, so that it can be suitable for high-resolution display devices.

In some embodiments, the data line 3 is provided with a bearing portion 9, a width of the bearing portion 9 is larger than a width of the data line 3, a side of the bearing portion 9 away from the base substrate 1 is provided with a spacer, and an orthographic projection of the spacer on the base substrate 1 is located within an orthographic projection of the bearing portion 9 on the base substrate 1.

In some embodiments, with reference to FIGS. 11a and 11b, the bearing portion 9 is provided on the data line 3 so that the bearing portion 9 is located in the edge region of the pixel unit, thereby reducing the shielding on the pixel region, and further improving the aperture ratio. The width of the bearing portion 9 is larger than the width of the data line 3, so that the data line 3 can obtain a larger bearing area and the bearing effect of the spacer can be improved, and the bearing portion 9 is covered with a light shield layer, so that the black matrix layer 8 arranged on the bearing portion 9 is wider to prevent the spacer from sliding out of the black matrix layer 8 and generating scratches on the film layer, and the light transmittance effect of the pixel region is ensured. It should be noted that, the black matrix layer 8 may be produced by coating, exposure, development, baking, or the like, and this will not be described herein.

In addition, a Color Film (CF) layer 10 is also provided at a side of the black matrix layer 8 away from the base substrate 1, which can prevent color mixing or color crossing between adjacent pixel regions, and can play a shielding role against external light, and prevent the problem that the photo-generated current is generated in a thin film transistor due to illumination, which causes an increase in the current of the thin film transistor in the off state, which will not be described here.

Based on the same inventive concept, an embodiment of the present disclosure further provides a display apparatus including the display panel of any one of the above embodiments. The display apparatus includes the display panel described in any one of the above embodiments, and therefore, the display apparatus has all the advantages and all the beneficial effects of the display panel in the above embodiments, and the display apparatus provided by an embodiment of the present disclosure may be applied to products or components including an LCD display panel, such as a display or a television, and will not be described in detail here.

It should be noted that the method in the embodiments of the present disclosure may be performed by a single device such as a computer, a server or the like. The method in the embodiments of the present disclosure may also be applied in a distributed scenario, and is accomplished by cooperation of a plurality of devices. In such case of the distributed scenario, one of the plurality of devices may execute only one or more acts in the method in embodiments of the present disclosure, and the plurality of devices interact with each other to accomplish the method.

It should be noted that some embodiments of the present disclosure have been described above. Other embodiments fall within the scope of the appended claims. In some cases, actions or acts recorded in the claims may be performed in an order different from those in the above-described embodiments and may still achieve desired results. In addition, processes illustrated in the drawings do not necessarily require a specific order or continuous order illustrated to achieve the desired results. In some embodiments, multitask processing and parallel processing are feasible or possibly advantageous.

Those skilled in the art should understand that the discussion in any of the above embodiments is only exemplary but is not intended to imply that the scope of the present disclosure (including the claims) is limited to these examples. Under the concept of the present disclosure, the above embodiments or the technical features in different embodiments may be combined, and the acts may be implemented in any order. There are many other changes in different aspects of the embodiments of the present disclosure as described above, which are not provided in details for simplicity.

Furthermore, to simplify the explanation and discussion and to avoid obscuring embodiments of the present disclosure, an apparatus may be illustrated in a form of a block diagram in order to avoid obscuring embodiments of the present disclosure, and a following fact is also considered, that is, details about implementation modes of apparatuses in these block diagrams highly depend on a platform on which embodiments of the present disclosure will be implemented (that is, these details should be fully within a understanding range of those skilled in the art). In the case where specific details are set forth to describe exemplary embodiments of the present disclosure, it would be apparent to those skilled in the art that the embodiments of the present disclosure may be implemented without these specific details or with changes in these specific details. Therefore, these descriptions should be considered illustrative rather than restrictive.

Although the present disclosure is described in combination with embodiments of the present disclosure, many replacements, modifications, and variations of these embodiments are apparent to those skilled in the art according to the previous description.

Embodiments of the present disclosure are intended to cover all such alternatives, modifications, and variations that fall in the broad scope of the appended claims. Therefore, any omissions, modifications, equivalent replacements, improvements, etc., made within the essence and principle of embodiments of the present disclosure shall be included within the protection scope of the present disclosure.

1. A display panel, comprising
a base substrate on which at least two gate lines and at least two data lines are disposed, wherein the gate lines and the data lines are insulated and crossed on the base substrate to form pixel regions;
a pixel electrode disposed at a side of the base substrate close to the pixel regions, wherein the pixel electrode is connected a to data line; and
a common electrode disposed at a side of the gate line and the data line away from the base substrate, wherein an orthographic projection of the common electrode on the base substrate covers an orthographic projection of the gate line and/or an orthographic projection of the data line on the base substrate.

2. The display panel according to claim 1, wherein
when the display panel adopts positive liquid crystal, the orthographic projection of the common electrode on the base substrate covers the orthographic projection of the gate line on the base substrate; and
when the display panel adopts negative liquid crystal, the orthographic projection of the common electrode on the base substrate covers the orthographic projection of the data line on the base substrate.

3. The display panel according to claim 1, wherein the common electrode comprises:
a first electrode layer disposed at the side of the gate line and the data line away from the base substrate, and disposed at a side of the pixel electrode away from the base substrate; and
a domain display region comprising a plurality of parallel slits provided on the first electrode layer, wherein a first shield electrode is formed at a slit of adjacent pixel regions, and an orthographic projection of the first shield electrode on the base substrate covers the orthographic projection of the gate line on the base substrate.

4. The display panel according to claim 3, wherein the first shield electrode is disposed parallel to the gate line.

5. The display panel according to claim 1, wherein the common electrode further comprises:
a second shield electrode disposed between adjacent pixel regions, wherein an orthographic projection of the second shield electrode on the base substrate covers the orthographic projection of the data line on the base substrate.

6. The display panel according to claim 5, wherein when the display panel adopts negative liquid crystal, the second shield electrode is disposed at the side of the data line away from the base substrate.

7. The display panel according to claim 1, wherein the common electrode comprises:
a second electrode layer disposed at the side of the gate line and the data line away from the base substrate and at a side of the pixel electrode close to the base substrate, and an orthographic projection of the second electrode layer on the base substrate covers the orthographic projection of the gate line and/or the orthographic projection of the data line on the base substrate.

8. The display panel according to claim 7, wherein
when the display panel adopts negative liquid crystal, the second electrode layer is disposed at the side of the data line away from the base substrate; and
when the display panel adopts positive liquid crystal, the second electrode layer is disposed at the side of the gate line away from the base substrate.

9. The display panel according to claim 3, wherein an end surface of the slit close to the data line is configured as a planer surface or an arc surface.

10. The display panel according to claim 3, wherein at least two domain display regions are provided in a pixel region, and directions of slits in adjacent domain display regions are different to enable a cross-domain region to be formed between adjacent two domain display regions.

11. The display panel according to claim 10, further comprising:
a common line, disposed at the side of the base substrate close to the pixel regions and connected to the common electrode, wherein an orthographic projection of the common line on the base substrate is overlapped with an orthographic projection of the cross-domain region on the base substrate;
or disposed at the side of the base substrate close to the pixel regions and connected to the common electrode, wherein an extension direction of the common line is the same as an extension direction of the data line, and a distance between the common line and the data line is set to be 4 μm to 10 μm.

12. The display panel according to claim 11, further comprising:
a black matrix layer disposed in the cross-domain region and shielding the common line.

13. The display panel according to claim 11, wherein the common line is disposed at a side of the data line, and an extension direction of the common line is the same as an extension direction of the data line.

14. The display panel according to claim 1, further comprising:
an organic film layer disposed at the side of the gate line and the data line away from the base substrate, wherein the organic film layer is disposed at a side of the common electrode close to the base substrate.

15. The display panel according to claim 1, wherein the data line is provided with a bearing portion having a width larger than a width of the data line, a spacer is disposed at a side of the bearing portion away from the base substrate, and an orthographic projection of the spacer on the base substrate is located within an orthographic projection of the bearing portion on the base substrate.

16. A display apparatus, comprising the display panel according to claim 1.

17. The display panel according to claim 11, wherein the common line is electrically connected with the common electrode through a first via of an insulator layer, the insulator layer comprises a passivation layer or an organic film layer, and the first via is overlapped with the gate line in a direction perpendicular to the display panel.

18. The display panel according to claim 11, wherein the data line is provided with a bearing portion having a width larger than a width of the data line, the common line protrudes towards the cross-domain region in a direction close to the bearing portion, the cross-domain region is a region formed between adjacent two domain display regions.

19. The display panel according to claim 18, wherein the common line is connected with the common electrode through a second via of an insulator layer, a thin film transistor is electrically connected with the pixel electrode through a third via, and in a direction along the gate line, the second via and the third via are disposed at two sides of the cross-domain region.

20. The display panel according to claim 3, wherein the common electrode further comprises:
a second shield electrode disposed between adjacent pixel regions, wherein an orthographic projection of the second shield electrode on the base substrate covers the orthographic projection of the data line on the base substrate.
